(19) United States
(12) Patent Application Publication
(10) Pub. No.: US 2026/0302935 A1
(43) Pub. Date: Oct. 1, 2026

(54) REDUCED EMI FOUR-LEGGED SINGLE-PHASE INVERTER SYSTEM AND METHOD THEREOF

(71) Applicant: The United States of America as Represented by the Secretary of the Navy, Arlington, VA (US)

(72) Inventors: Giovanna Oriti, Seaside, CA (US); Alexander Lloyd Julian, Seaside, CA (US)

(21) Appl. No.: 19/089,205

(22) Filed: Mar. 25, 2025

(51) Int. Cl. H02M 1/44; H02M 7/537

(52) U.S. Cl. CPC H02M 1/44; H02M 7/537

(57) ABSTRACT

A common mode voltage reducing single-phase inverter comprising: an energy source electrically coupled to a first, a second, a third, and a fourth half-bridge circuits; a positive alternating current (AC) bus rail electrically coupled to the first and the second half bridge circuits and having a Linep output electrically coupled to a phase load; a negative AC bus rail electrically coupled to the third and fourth half-bridge circuits and having an Linen output electrically coupled to a phase load; and a control circuit electrically coupled to multiple transistors of the first, the second, the third, and the fourth half-bridge circuits.

### STATEMENT OF GOVERNMENT INTEREST

The present disclosure was made in the performance of official duties by one or more employees of the Department of the Navy, and thus, embodiments herein may be manufactured, used or licensed by or for the Government of the United States of America for governmental purposes without the payment of any royalties thereon or therefor.

### FIELD OF USE

The present disclosure relates, in general, to a system and method of reducing electromagnetic interference of single-phase inverters. More specifically, the present disclosure relates to a four-legged single-phase inverter.

### BACKGROUND

Generally, single-phase inverters generate an alternating current (AC) output waveform that ideally resembles a sinusoidal waveform from a direct current (DC) source. The sinusoidal waveform is usually created by rapidly switching a DC input to create a sine wave pulse-shaped signal.

When power semiconductor devices switch quickly, they can create conducted and radiated electromagnetic interference (EMI) from parasitic voltages and currents. Faster switching times in power electronics can lead to faster voltage and current signal rise and fall times, which produce more energy at high frequencies. These harmonics are the leading cause of EMI in inverters.

Parasitic voltages and currents are unwanted and unintended electrical voltages or currents in circuits due to unavoidable capacitances and inductances within a circuit design. Parasitic voltages and currents may be common mode voltages (CMV) or currents (CMI) occurring along the lines and components of a closed loop simultaneously, in the same direction, and in phase with respect to a common reference ground.

EMI is unwanted noise or interference in an electrical circuit or path caused by an external source. EMI is also known as radio frequency interference (RFI) in the radio frequency spectrum. EMI may be transmitted through radiated or conducted paths, or both, from one electronic device to another. EMI may be caused by inherent noise created within an electrical device by thermal agitation, such as electrons moving through a circuit resistor; natural EMI caused by natural events, such as lightning, electric storms, loud sounds, or the Earth's magnetic fields; human-made EMI produced by electronic equipment, such as cell phones, medical equipment, microwave ovens, and speakers, harmonic magnetic fields, and RF fields.

EMI is further classified into common mode (CM) and differential mode (DM) EMI. DM EMI is a conducted electromagnetic interference (EMI) noise between two conductors within a cable or on a printed circuit board (PCB) and is characterized by two signals 180 degrees out of phase and flowing in opposite directions on the wire. CM EMI occurs along the lines of a closed loop simultaneously, in the same direction and in phase current with respect to a common reference ground. It is usually caused by high-frequency currents flowing in the same direction down both interconnect lines and through the parasitic capacitance of diodes, transistors, and transformers to ground in a power circuit.

Switching of power semiconductor devices in single-phase inverters typically produces conducted and radiated EMI. EMI in circuits and inverters has traditionally been mitigated through various techniques such as filtering, shielding, grounding, and soft-switching. Filtering, shielding, and grounding are considered to be hardware-type mitigations requiring increased complexity, size, weight, cost, and potential for unintended consequences such as reduced performance or difficulty in implementation in high-speed or sensitive applications. Soft switching may reduce EMI by minimizing switching transients and losses, but it does not eliminate the EMI entirely. High frequency switching action of power electronics may still generate EMI, and soft switching techniques primarily focus on reducing this interference, not completely removing it.

Therefore, a method and system for reducing EMI produced by single-phase DC to AC inverters are needed.

The background section is provided to reveal information believed by the applicant to be of possible relevance to the present technology. No admission is necessarily intended, nor should be construed, that any of the preceding information constitutes prior art against the present technology.

### SUMMARY

To minimize the limitations in the prior art, and to minimize other limitations that will become apparent upon reading and understanding the present specification, the present disclosure discloses a new and useful reduced EMI four-legged single-phase inverter.

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

The problem with common mode electromagnetic interference produced during the conversion of DC to AC in signal phase inverters is solved by a CM voltage-reducing control strategy of a four-legged inverter.

Disclosed is a four-legged single-phase inverter, with inverter half-bridge circuits (legs) connected in pairs and controlled using pulse density modulation (PDM). Components with a reduced voltage and current rating may be used for each leg because the legs are connected in pairs and share a supplied current.

One embodiment of the present disclosure may be a common mode voltage reducing single-phase inverter comprising: an energy source electrically coupled to each of a first, a second, a third, and a fourth half-bridge circuits; a positive alternating current (AC) bus rail electrically coupled to the first and the second half-bridge circuits and having a Linep output electrically coupled to a phase load; a negative AC bus rail electrically coupled to the third and fourth half bridge circuits and having an Linen output electrically coupled to a phase load; and a control circuit electrically coupled to multiple transistors of the half-bridge circuits. Wherein a first half-bridge circuit and a second half-bridge circuit share an output current of the Linep output; and wherein each of a third half-bridge circuit and a fourth half-bridge circuit share an output current of the linen output. Wherein an output voltage may be controlled by a proportional integral controller in a synchronous dq reference frame. Wherein a measured Vac may be used to orthogonally generate voltages in an αβ frame. Wherein the control circuit controls the multiple transistors by pulse density modulation (PDM); wherein the PDM may be a fixed frequency. Wherein a current error may be identified for each of the first, the second, the third, and the fourth half-bridge circuits; wherein the control circuit samples and updates the multiple transistors at the fixed frequency; wherein a top transistor of any two of the half-bridge circuits, having the largest current error may be turned on, thereby conducting from a positive power bus of the energy source; and wherein a bottom transistor of any two of the half-bridge circuits, having the lowest current error may be turned on, thereby conducting to a negative power bus of the energy source. Wherein the control circuit updates the top two transistors and the bottom two transistors with an error ranking algorithm. Wherein the energy source may be a direct current (DC) source, and the DC source may be selected from the group of DC sources consisting of: a battery, a solar cell, a fuel cell, a thermal conversion device, and a biomass. The inverter may further including a bypass capacitor configured to filter high frequency electromagnetic interference.

An alternate embodiment of the present disclosure may be a micro-grid common mode voltage reducing 4-legged single-phase inverters comprising: an energy source electrically coupled to each of a first, a second, a third, and a fourth half-bridge circuits; a positive alternating current (AC) bus rail electrically coupled to the first and the second half-bridge circuits and having an Lp output electrically coupled to a phase load; a negative AC bus rail electrically coupled to the third and fourth half-bridge circuits and having an Ln output electrically coupled to a phase load; and a control circuit electrically coupled to multiple transistors of the first, the second, the third, and the fourth half-bridge circuits. Wherein a first half-bridge circuit and a second half-bridge circuit share a voltage-current rating; and wherein a third half-bridge circuit and a fourth half-bridge circuit share a voltage-current rating. Wherein the output voltage may be controlled by a proportional integral controller in a synchronous dq reference frame. Wherein a measured Vac may be used to orthogonally generate voltages in an αβ frame. Wherein the control circuit controls the multiple transistors by pulse density modulation (PDM); wherein the PDM may be a fixed frequency. Wherein a current error may be identified for each half-bridge circuits; wherein the control circuit samples and updates the multiple transistors at the fixed frequency; wherein a top transistor of any two half-bridge circuits having the largest current error may be electrically coupled to a positive direct current (DC) bus of the energy source; and wherein a bottom transistor of any two half-bridge circuits having the lowest current error may be electrically coupled to a negative DC bus of the energy source. Wherein the control circuit updates the top two transistors and the bottom two transistors with an error ranking algorithm. Wherein the energy source may be a direct current (DC) source, and the DC source may be selected from the group of DC sources consisting of: a battery, a solar cell, a fuel cell, a thermal conversion device, and a biomass.

An alternate embodiment of the present disclosure may be a method of reducing common mode voltage electromagnetic interference in a single-phase inverter, the method comprising: receiving, by a 4-legged inverter, current from an energy source, wherein the energy source may be a direct current energy source; controlling, by a controller, a flow of current from the energy source through multiple transistors of half-bridge circuits; switching, by the multiple transistors, to create a sinusoidal electrical power output waveform; controlling, by the controller, output voltage in a synchronous dq frame; sampling, by the controller, a current of each half-bridge circuits; identifying, by the controller, a largest current error in any two half-bridge circuits; updating, by the controller, the multiple transistors of the half-bridge circuits; wherein a top transistor of any two of the half-bridge circuits having the largest current error may be turned on, thereby conducting from a positive power bus of the energy source; and wherein a bottom transistor of any two half-bridge circuits having the lowest current error may be turned on, thereby conducting to a negative power bus of the energy source; and outputting, by the single-phase inverter, a sinusoidal electrical power output waveform. Wherein the controller controls the flow of current through the multiple transistors by pulse density modulation (PDM); wherein the PDM may be a fixed frequency. Wherein the updating may be based at least in part on an error ranking algorithm.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of one embodiment of a reduced electromagnetic interference (EMI) 4-legged single-phase inverter.

FIG. 2 is an illustration of one embodiment of a voltage controller for a reduced electromagnetic interference (EMI) 4-legged single-phase inverter.

FIG. 3 is an illustration of one embodiment of a current controller for a reduced electromagnetic interference (EMI) 4-legged single-phase inverter.

FIG. 4 is a graph showing output voltage and out-of-phase currents between the positive bus pair and the negative bus pair.

FIG. 5 is a spectral graph showing the total harmonic distortion of the output voltage.

FIG. 6 is a spectral graph showing conducted electromagnetic interference (EMI).

FIG. 7 is an illustration of one embodiment of a three-phase, 4-legged inverter.

FIG. 8 is one embodiment of a ZA modulation controller.

FIG. 9 is a flow block diagram of one method of reducing EMI generated by signal phase inverters.

### DETAILED DESCRIPTION OF THE ILLUSTRATIVE EMBODIMENTS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the devices, systems, and methods of the present disclosure will become apparent to those skilled in the art from the following detailed description, which shows and describes illustrative embodiments of the devices, systems, and methods of the present disclosure. As will be realized, the devices, systems, and methods of the present disclosure are capable of modifications in various obvious aspects, all without departing from the spirit and scope of the present disclosure. Accordingly, the screenshot figures, and the detailed descriptions thereof, are to be regarded as illustrative in nature and not restrictive. Also, the reference or non-reference to a particular embodiment of the devices, systems, and methods of the present disclosure shall not be interpreted to limit the scope of the present disclosure.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

Furthermore, the one or more versions may be implemented as a method, apparatus, or article of manufacture using standard programming and/or engineering techniques to produce entirely hardware embodiment, an entirely software embodiment, or an embodiment combining software and hardware embodiments. Furthermore, the systems and methods may take the form of Non-transitory computer readable media. More particularly, the present methods and systems may take the form of web-implemented computer software or a computer program product. Any suitable computer-readable storage medium may be utilized including, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick).

Those skilled in the art will recognize many modifications may be made to this configuration without departing from the scope of the disclosed embodiments.

Embodiments of the systems and methods are described below with reference to schematic diagrams, block diagrams, and flowchart illustrations of methods, systems, apparatuses and computer program products. It will be understood that each block of the block diagrams, schematic diagrams, and flowchart illustrations, and combinations of blocks in the block diagrams, schematic diagrams, and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of the various embodiments of the device, method, and/or system. For example, as used herein, the terms “computer” and “computer system” generally refer to any device that processes information with an integrated circuit chip and/or central processing unit (CPU).

As used herein, the terms “software” and “application” refer to any set of machine-readable instructions on a machine, web interface, and/or computer system” that directs a computer's processor to perform specific steps, processes, or operations disclosed herein.

As used herein, the term “computer-readable medium” refers to any storage medium adapted to store data and/or instructions that are executable by a processor of a computer system. The computer-readable storage medium may be a computer-readable non-transitory storage medium and/or any non-transitory data storage circuitry (e.g., buggers, cache, and queues) within transceivers of transitory signals. The computer-readable storage medium may also be any tangible computer readable medium. In various embodiments, a computer readable storage medium may also be able to store data, which is able to be accessed by the processor of the computer system.

As used herein, the term “Band gap” refers to the energy difference between the valence band's top and the conduction band's bottom in semiconductors.

As used herein, the term “common mode” or “CM” refers to electromagnetic interference that occurs along the lines of a closed loop simultaneously in the same direction and in phase current with respect to a common reference ground.

As used herein, the term “dead time” refers to a small intentional delay introduced between the turn-off signal of one power switching device and the turn-on signal of the other device in a half-bridge circuit.

As used herein, the term “driving” refers to actively controlling another circuit by providing the necessary voltage, current, or signal to power and or operate the target circuit.

As used herein, the term “electromagnetic interference (EMI)” refers to unwanted noise or interference in an electrical path or circuit.

As used herein, the term “leg” or “half-bridge inverter” refers to a single phase of an alternating current (AC) output, essentially representing one of the power switching circuits within an inverter that contributes to generating a complete AC waveform.

As used herein, the term “phase” refers to a single alternating current (AC) waveform within a system.

As used herein, the term “wide bandgap” or “wide band gap semiconductors” refers to semiconductor materials with a larger band gap than conventional semiconductors. Conventional semiconductors, like silicon, have a band gap of 0.6-1.5 electron volts, while wide-band gap (WBG) materials have band gaps above 2 electron volts.

Wide bandgap devices, such as but not limited to SiC and GaN, may have fast switching capabilities, which may allow for higher efficiency and power density. The increase in switching capabilities means that the voltage and current slew rates (dv/dt and di/dt) may be high, which may generate significant electromagnetic interference (EMI). Lowering current through a device and using a reduced current-rated WBG device may help mitigate EMI but may also reduce the device's overall performance capabilities.

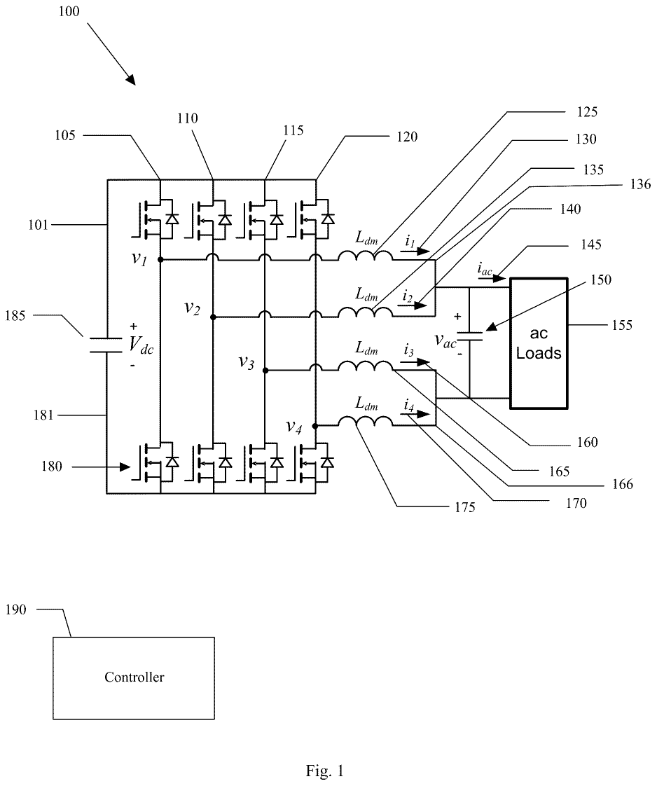

The disclosed system and method introduce a four-legged single-phase inverter, with the inverter legs connected in pairs as shown in FIG. 1, where the current rating of the switching semiconductors may be reduced by as much as 50% with respect to a typical full-bridge with two legs. A reduction in the volt-amperes rating of the semiconductors may also lead to a reduction in component costs, as compared to other topologies that may also mitigate CM. Additionally, the disclosed four-legged single-phase inverter and method may improve DM performance while producing nearly zero CM voltage.

FIG. 1 is an illustration of one embodiment of a reduced electromagnetic interference (EMI) 4-legged single-phase inverter. Inverter 100 may include multiple half-bridge circuits 105, 110, 115, and 120, multiple differential mode (DM) inductors 125, 135, 165, and 175, first positive bus currents 130, second positive bus current 140, first negative bus currents 160, second negative bus currents 170, output current 145 output, DM capacitor filter 150, alternating current (AC) load 155, Positive bus pair 136 and negative bus pair 166, multiple transistors 180, direct current (DC) power source 185, positive DC bus 101, negative DC bus 180, and controller 190.

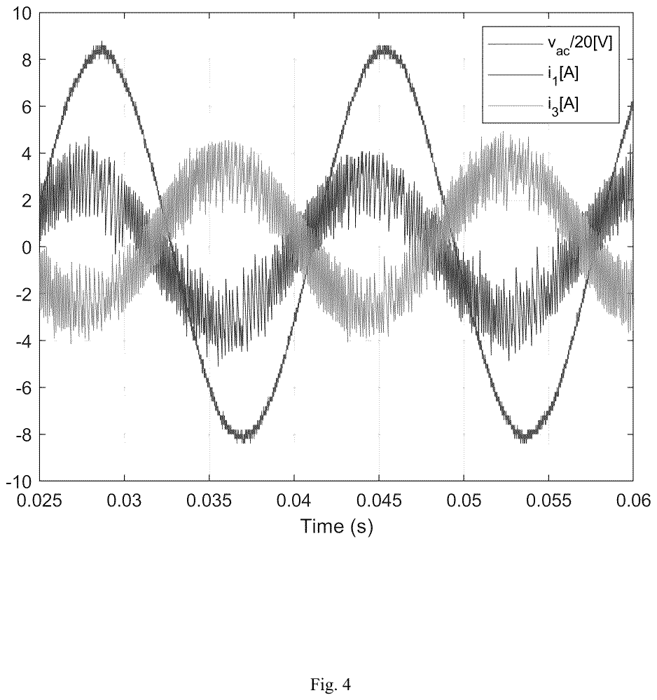

Multiple half-bridge circuits 105, 110, 115, and 120 may comprise multiple transistors 180 that may be switched on and off at a rate and pattern to produce a sinusoidal power waveform (as shown in FIG. 4). Multiple transistors 180 in half-bridge circuits 105, 110, 115, and 120 may be but should not be limited to bipolar junction transistors (BJTs), field-effect transistors (FETs), metal oxide semiconductor field-effect transistors (MOSFET), and insulated gate bipolar transistor (IGBTs). It is preferable that the transistors be able to switch at high speeds, be voltage controlled, have low conduction losses, and be easy to use. Multiple transistors 180 of half-bridge circuits 105, 110, 115, and 120 may be switched from 50 kHz to 4 MHz Switching speeds may be limited by electromagnetic interference (EMI) standards and tolerances.

Each half-bridge circuits 105, 110, 115, and 120 may include multiple differential mode (DM) inductors 125, 135, 165, and 175 to filter high-frequency components of voltage and current that may be generated through the operation of half-bridge circuits 105, 110, 115, and 120. Half-bridge circuit 105 may provide first positive bus current 130, which may be twenty-five percent of output current 145. Half-bridge circuit 110 may provide second positive bus currents 140, which may be twenty-five percent of output current 145. Half-bridge circuit 115 may provide first negative bus currents 160, which may be twenty-five percent of output current 145. Half-bridge circuit 120 may provide second negative bus currents 170, which may be twenty-five percent of output current 145. Half-bridge circuits 105 and 110 may form positive bus pair 136, and half-bridge circuits 115 and 120 may form a negative bus pair 166. Positive bus pair 136 and negative bus pair 166 may provide output current 145. Positive bus pair 136 may provide fifty percent of output current 145, and negative bus pair 166 may provide fifty percent of output current 145.

AC load 155 may be a device or system that consumes AC electrical power, such as appliances, equipment, or even a building's overall cooling needs.

DC power source 185 may be a smaller power generator or one or more energy storage units located remotely, installed on-site, connected to a local electric power grid, or isolated in a microgrid. DC power source 185 may include positive DC bus 101 and negative DC bus 181. Positive DC bus 101 may be the source of electrical current, and negative DC bus 181 may serve as a common reference point or return. DC power source 185 may be used for but should not be limited to meeting goals and mandates, providing revenue streams, lowering the overall cost of a microgrid, and providing power during a grid outage. DC power source 185 may be small-scale technologies that generate and provide energy, improve reliability, and reduce costs. DC power source 185 may include but should not be limited to solar panels, wind turbines, storage systems, batteries, combined heat, and power (CHP) systems, charging stations, grid-interactive buildings, and microgrids.

Controller 190 may include but should not be limited to an FPGA, microcontroller, oscillating circuit, or any other control or regulating circuits. Controller 190 may control multiple transistors 180 of each half-bridge circuits 105, 110, 115, and 120. Controller 190 may control the flow of current from DC power source 185.

DM capacitor filter 150 may be added between positive bus pair 136 and negative bus pair 166 to filter high-frequency components of voltage and current that may be generated through the operation of half-bridge circuits 105, 110, 115, and 120.

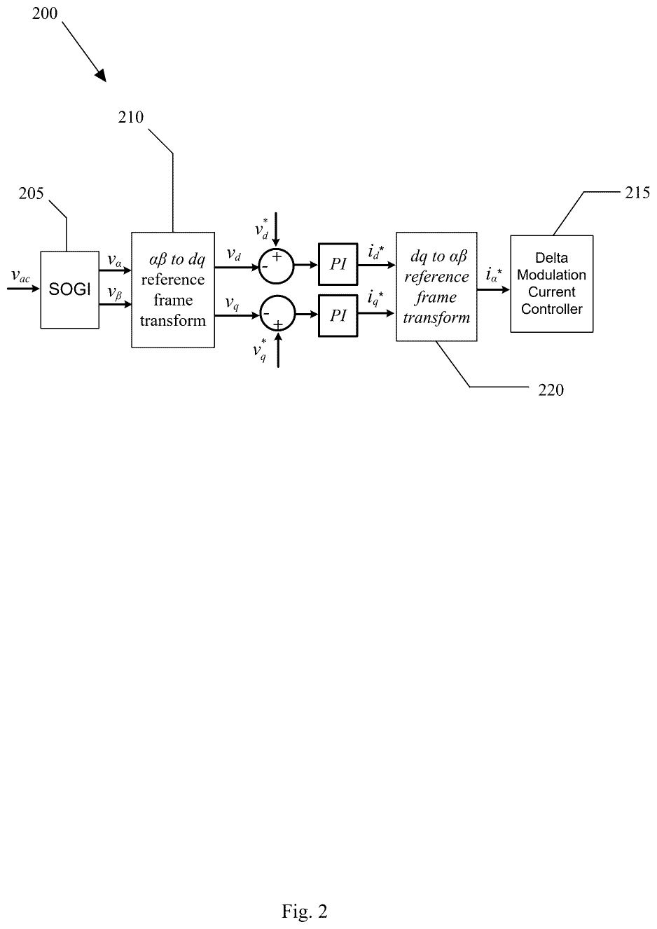

FIG. 2 is an illustration of one embodiment of a voltage controller for a reduced electromagnetic interference (EMI) 4-legged single-phase inverter. Voltage controller 200 may include delta modulation current controller 215, αβ reference frame 220, dq reference frame 210, and second-order generalized integrator (SOGI) 205.

The inverter's output voltage may be controlled by proportional-integral (PI) controllers in synchronous dq reference frame 220. This requires that the measured single-phase AC voltage Vac be used to create the voltages in αβ reference frame 220 using an orthogonal generation method known as SOGI 205. Subsequently, the voltages vα and vβ generated are transformed into the dq reference frame 220, where PI controllers may be implemented on each axis.

$${v}_{α} = {v}_{a c} \frac{k {ω}_{0} s}{{s}^{2} + k {ω}_{0} s + {ω}^{2}} {v}_{β} = {v}_{a c} \frac{k {ω}_{0}}{{s}^{2} + k {ω}_{0} s + {ω}^{2}} \qquad ( 1 )$$

The outputs of the PI controllers may be the current references i_{d} and i_{q} in the dq references frame, as depicted in FIG. 2. These current references are then transformed to the αβ reference frame, producing the current reference iα. In the next step, the control system produces the reference currents for the inner current control loop shown in FIG. 2 as follows:

$${i}_{1}^{*} = {i}_{2}^{*} = {i}_{a}^{*} {i}_{3}^{*} = {i}_{4}^{*} = - {i}_{a 2}^{*} \qquad ( 2 )$$

In an alternative embodiment, an enhanced SOGI (ESOGI) may be used to extract fundamental components from nonlinear load current and distorted output voltages.

Any voltage controller 200 should preferably ensure high-quality injected currents, proper synchronization with the network, and satisfactory performance of the system when faced with a network failure scenario.

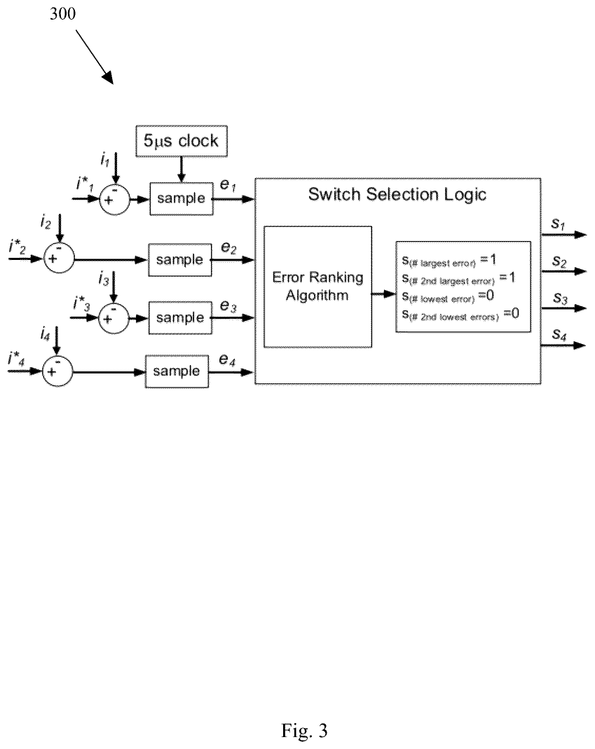

FIG. 3 is an illustration of one embodiment of a current controller for a reduced electromagnetic interference (EMI) 4-legged single-phase inverter. Inner current control loop 300, as shown in FIG. 3, may be nested inside voltage controller 200 and may implement delta modulation, a PDM method, which may allow for updates at a fixed frequency, unlike PWM. The current error for each converter leg may be sampled at a fixed frequency, and multiple transistors 180 may preferably be updated at the same frequency. At every update, the half-bridge circuits 105, 110, 115, and 120, which have the largest current errors, may be switched to DC bus 101, and the other two may be switched to negative DC bus 181. The modulation strategy may select two top transistors 180 and two bottom transistors 180 at every switching event using an error ranking algorithm. This preferably achieves a theoretical elimination of the CM voltage at the output of the inverter. as defined by each leg voltage with respect to the mid-point of the DC bus:

$${v}_{c m} = \frac{{v}_{1} + {v}_{2} + {v}_{3} + {v}_{4}}{4}$$

In this topology, the sum of the four voltages is zero because, at any time, two of the inverter voltages are equal to Vdc/2, and the other two are −Vdc/2.

FIG. 4 is a graph showing output voltage and out-of-phase currents between the positive bus pair and the negative bus pair. Although not required, a full EMI filter is not necessary to meet the CM tolerances; small bypass capacitors may be added to attenuate high-frequency EMI, as shown in FIG. 1.

The inverter output voltage and the currents on two inverter legs are shown in FIG. 4, and it shows that the control system may regulate the output voltage by outputting good power quality. As shown in FIG. 4, the waveforms indicate an output voltage regulated at 115 volts, and the currents on the inverter legs are 180° out of phase with each other as designed.

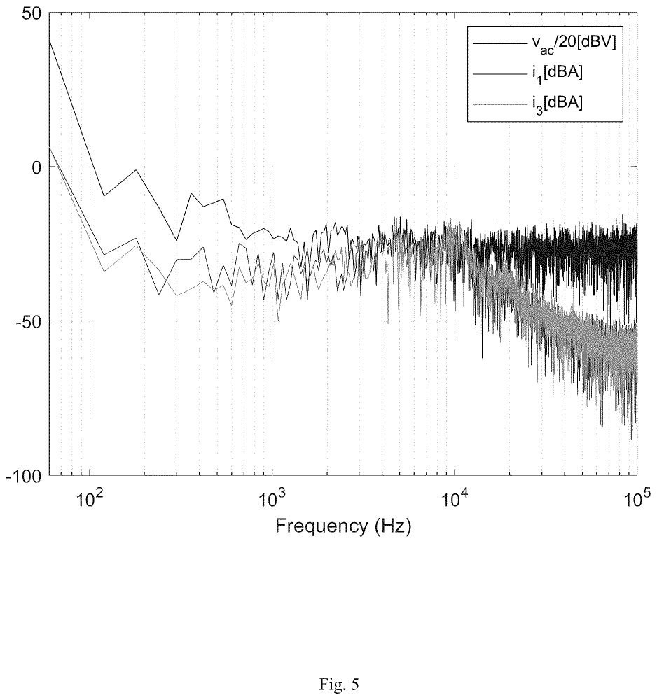

FIG. 5 is a spectral graph showing the total harmonic distortion of the output voltage. FIG. 5 shows a fast Fourier transform (FFT) spectra of the positive bus pair 136 and negative bus pair 166 waveforms that show intolerance DM performance of inverter 200. As shown in FIG. 5, the output voltage's total harmonic distortion (THD) is approximately 1.2%.

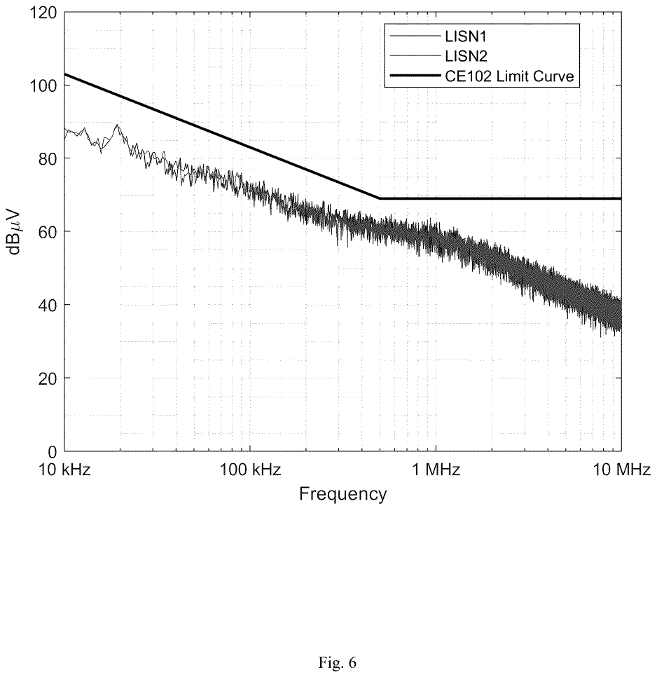

FIG. 6 is a spectral graph showing conducted electromagnetic interference (EMI). FIG. 6 shows conducted emissions of EMI from a 220-volt DC bus voltage. The resulting spectra shows that for the CE102 frequency range of 10 kHz through 150 kHz, EMI consistently remains below the CE102 limit curve across the evaluated frequency range without a CM choke.

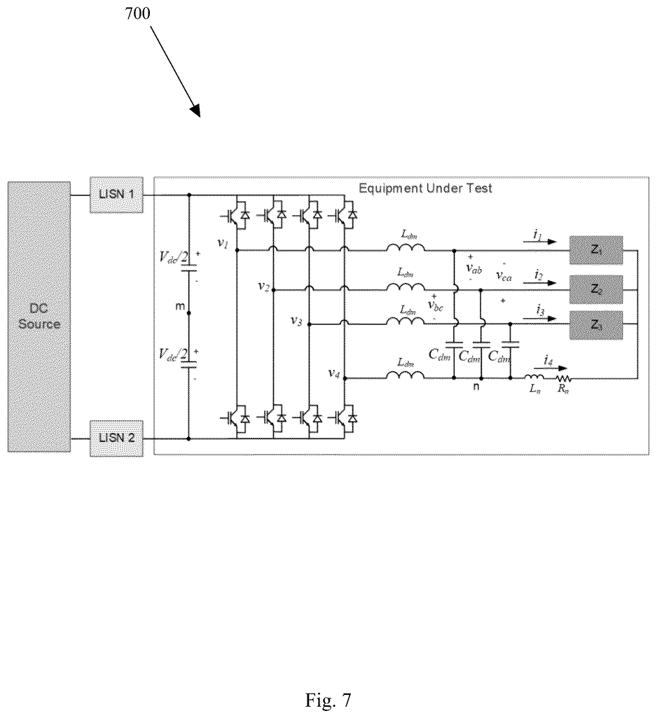

FIG. 7 is an illustration of one embodiment of a three-phase, 4-legged inverter. CM voltage in switching power converters has been known to cause EMI and ground currents in a variety of inverter applications, including motor drive systems. WBG inverters may be used where higher switching frequencies, efficiencies, and power densities are required. As shown in FIG. 7, WBG inverters 700 typically require passive or active filtering solutions to mitigate EMI caused by CM-conducted emissions (CE) due to higher switching frequencies. Sigma-delta modulation (ZAM) based on PDM has proven to improve CM elimination three-phase four-leg inverters to meet MIL-STD-461G CE tolerances.

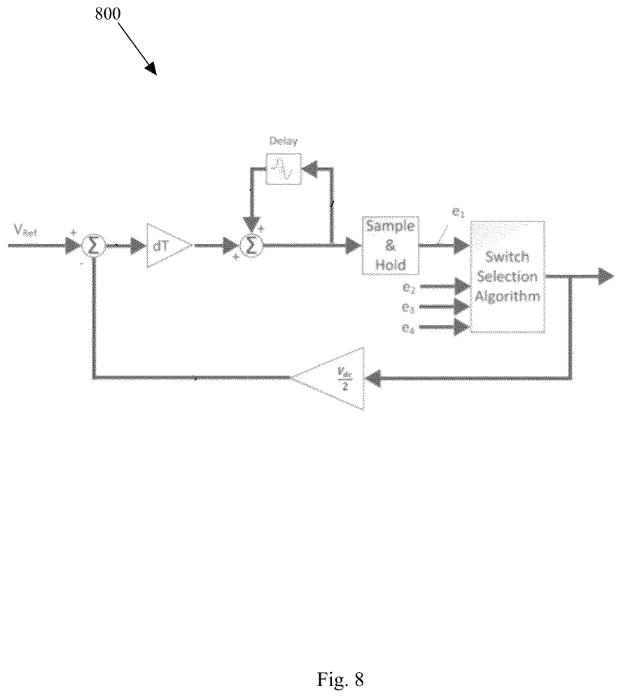

FIG. 8. is one embodiment of a ZA modulation controller. Sigma-delta modulation controller 800 may be implemented to output phase voltage 820, which substantially represents the reference voltage in both phase and amplitude. The output phase 820 voltage may be either +Vdc/2 or −Vdc/2 because either the top switch per phase is turned on (+V) or the bottom switch is turned on (−V). The assumed voltages may be calculated using the +V and −V multiplied by Vdc/2 and then compared with the reference voltages because there are only two voltages. Therefore, any error generated by comparing the reference voltage and the assumed voltage may be integrated and then compared with zero as a running error to determine a switching state. A running error may enable the transition control of the output switching states. For example, if the running error is getting larger than zero, the output is selected to be +V; if the error is getting less than zero, the output would be −V; and if there is no sign change, the output is held to either +Vdc/2 or −Vdc/2. Therefore, Sigma-delta modulation (SAM) may produce pulse density modulation (PDM) in each switching leg (half-bridge circuit) with a fundamental harmonic equal to the reference voltage input. A running error may update at each simulation time step, with the switching selection algorithm applied to each phase until all four phase errors are compared. A “hold” block may hold the algorithm output until each phase switching state is determined, and all four switching states may then be updated simultaneously for the inverter. The switching selection and hold block implementation is shown in FIG. 8, implemented by returning the phases that have the two largest errors, set to +V, and the two other phases are set to −V (+V or digital 1 means the top switch is on which indicates Vdc/2 and −V or digital 0 means the bottom switch is on associates with −Vdc/2). During each time instant, a “Max_index” may be the largest error phase, and “2nd_index” is the phase with the second largest error. The other two phases may be set to zero. This switching selection algorithm may update at 1 μs simulation step, which may be the update time of the output to the inverter switch leg. The table below shows an example of the switching states of the four-leg inverter.

| Switching States | CMV |
|---|---|
| 1111 | V_{dc}/2 |
| 1110, 1101, 1011, 0111 | V_{dc}/4 |
| 1110, 1001, 0011, 0101, 1010, 0110 | 0 |
| 0001, 0010, 0100, 1000 | −V_{dc}/4 |
| 0000 | −V_{dc}/2 |

As shown by the switching selection table, only the six switching states may generate zero CM voltages.

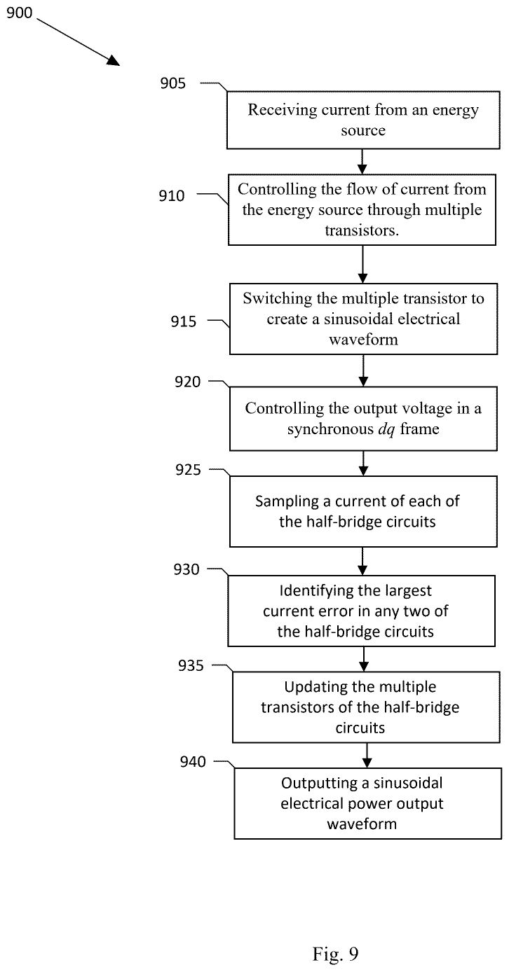

FIG. 9 is a flow block diagram of one method of reducing EMI generated by signal phase inverters.

Method of reducing common mode voltage electromagnetic interference in a single-phase inverter 900, the method comprising: receiving 905, by a 4-legged inverter, current from an energy source, wherein the energy source is a direct current energy source; controlling 910, by a controller, a flow of current from the energy source through multiple transistors of a first, a second, a third, and a fourth half-bridge circuits; switching 915, by the multiple transistors, to create a sinusoidal electrical power output waveform; controlling 920, by the controller, output voltage in a synchronous dq frame; sampling 925, by the controller, a current of each of the first, the second, the third, and the fourth half-bridge circuits; identifying 930, by the controller, a largest current error in any two of the first, the second, the third, and the fourth half-bridge circuits; updating 935, by the controller, the multiple transistors of the first, the second, the third, and the fourth half-bridge circuits; wherein a top transistor of any two of the first, the second, the third, or the fourth half-bridge circuits having the largest current error is turned on, thereby conducting from a positive power bus of the energy source; and wherein a bottom transistor of any two of the first, the second, the third, or the fourth half-bridge circuits having the lowest current error is turned on, thereby conducting to a negative power bus of the energy source; and outputting 940, by the single-phase inverter, a sinusoidal electrical power output waveform; wherein the controller controls the flow of current through the multiple transistors by pulse density modulation (PDM); wherein the PDM is a fixed frequency; wherein the updating is based at least in part on an error ranking algorithm.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

Some portions of the preceding detailed descriptions have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the present disclosure, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The processes or methods depicted in the figures may be performed by processing logic that comprises hardware (e.g., circuitry, dedicated logic, etc.), firmware, software (e.g., embodied on a non-transitory computer readable medium), or a combination thereof. Although the processes or methods are described above in terms of some sequential operations, it should be appreciated that some of the operations described may be performed in a different order. Moreover, some operations may be performed in parallel rather than sequentially.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A common mode voltage reducing single-phase inverter comprising:
an energy source electrically coupled to each of a first, a second, a third, and a fourth half-bridge circuits;
a positive alternating current (AC) bus rail electrically coupled to the first and the second half-bridge circuits and having a Linep output electrically coupled to a phase load;
a negative AC bus rail electrically coupled to the third and fourth half-bridge circuits and having an Linen output electrically coupled to a phase load; and
a control circuit electrically coupled to multiple transistors of the first, the second, the third, and the fourth half-bridge circuits.

2. The inverter of claim 1, wherein each of the first half-bridge circuit and the second half-bridge circuit share an output current of the Linep output; and
wherein each of the third half-bridge circuit and the fourth half-bridge circuit share an output current of the linen output.

3. The inverter of claim 1, wherein an output voltage is controlled by a proportional integral controller in a synchronous dq reference frame.

4. The inverter of claim 3, wherein a measured Vac is used to orthogonally generate one or more voltages in an αβ frame.

5. The inverter of claim 1, wherein the control circuit controls the multiple transistors by pulse density modulation (PDM);
wherein the PDM is a fixed frequency.

6. The inverter of claim 5, wherein a current error is identified for each of the first, the second, the third, and the fourth half-bridge circuits;
wherein the control circuit samples and updates the multiple transistors at the fixed frequency;
wherein a top transistor of any two of the first, the second, the third, or the fourth half-bridge circuits, having the largest current error is turned on, thereby conducting from a positive power bus of the energy source; and
wherein a bottom transistor of any two of the first, the second, the third, or the fourth half-bridge circuits, having the lowest current error is turned on, thereby conducting to a negative power bus of the energy source.

7. The inverter of claim 6, wherein the control circuit updates the top two transistors and the bottom two transistors with an error ranking algorithm.

8. The inverter of claim 1, wherein the energy source is a direct current (DC) source, and the DC source is selected from the group of DC sources consisting of one or more of:
a battery, a solar cell, a fuel cell, a thermal conversion device, and a biomass.

9. The inverter of claim 1, further including a bypass capacitor configured to filter high frequency electromagnetic interference.

10. A micro-grid common mode voltage reducing 4-legged single-phase inverters comprising:
an energy source electrically coupled to each of a first, a second, a third, and a fourth half-bridge circuits;
a positive alternating current (AC) bus rail electrically coupled to the first and the second half-bridge circuits and having an Lp output electrically coupled to a phase load;
a negative AC bus rail electrically coupled to the third and fourth half-bridge circuits and having an Ln output electrically coupled to a phase load; and
a control circuit electrically coupled to multiple transistors of the first, the second, the third, and the fourth half-bridge circuits.

11. The inverter of claim 10, wherein a first half-bridge circuit and a second half-bridge circuit share a voltage-current rating; and
wherein a third half-bridge circuit and a fourth half-bridge circuit share a voltage-current rating.

12. The inverter of claim 10, wherein the output voltage is controlled by a proportional integral controller in a synchronous dq reference frame.

13. The inverter of claim 12, wherein a measured Vac is used to orthogonally generate one or more voltages in an αβ frame.

14. The inverter of claim 10, wherein the control circuit controls the multiple transistors by pulse density modulation (PDM);
wherein the PDM is a fixed frequency.

15. The inverter of claim 14, wherein a current error is identified for each of the first, the second, the third, and the fourth half-bridge circuits;
wherein the control circuit samples and updates the multiple transistors at the fixed frequency;
wherein a top transistor of any two of the first, the second, the third, or the fourth half-bridge circuits having the largest current error is electrically coupled to a positive direct current (DC) bus of the energy source; and
wherein a bottom transistor of any two of the first, the second, the third, or the fourth half-bridge circuits having the lowest current error is electrically coupled to a negative DC bus of the energy source.

16. The inverter of claim 15, wherein the control circuit updates the top two transistors and the bottom two transistors with an error ranking algorithm.

17. The inverter of claim 10, wherein the energy source is a direct current (DC) source, and the DC source is selected from the group of DC sources consisting of one or more of: a battery, a solar cell, a fuel cell, a thermal conversion device, and a biomass.

18. A method of reducing common mode voltage electromagnetic interference in a single-phase inverter, the method comprising:
receiving, by a 4-legged inverter, current from an energy source, wherein the energy source is a direct current energy source;
controlling, by a controller, a flow of current from the energy source through multiple transistors of a first, a second, a third, and a fourth half-bridge circuits;
switching, by the multiple transistors, to create a sinusoidal electrical power output waveform;
controlling, by the controller, output voltage in a synchronous dq frame;
sampling, by the controller, a current of each of the first, the second, the third, and the fourth half-bridge circuits;
identifying, by the controller, a largest current error in any two of the first, the second, the third, and the fourth half-bridge circuits; and
updating, by the controller, the multiple transistors of the first, the second, the third, and the fourth half-bridge circuits;
wherein a top transistor of any two of the first, the second, the third, or the fourth half-bridge circuits having the largest current error is turned on, thereby conducting from a positive power bus of the energy source; and
wherein a bottom transistor of any two of the first, the second, the third, or the fourth half-bridge circuits having the lowest current error is turned on, thereby conducting to a negative power bus of the energy source; and
outputting, by the single-phase inverter, a sinusoidal electrical power output waveform.

19. The method of claim 18, wherein the controller controls the flow of current through the multiple transistors by pulse density modulation (PDM);
wherein the PDM is a fixed frequency.

20. The method of claim 18, wherein the updating is based at least in part on an error ranking algorithm.
